(19) United States
(12) Patent Application Publication
(10) Pub. No.: US 2008/0145126 A1
(43) Pub. Date: Jun. 19, 2008

(54) Controlled Application of Pigments to Select Regions on a Surface of a Substrate

(75) Inventor: David H. Levy, Cambridge, MA (US)

Correspondence Address: FISH & RICHARDSON PC, P.O. BOX 1022, MINNEAPOLIS, MN, 55440-1022, US

(73) Assignee: TH, Inc.

(21) Appl. No.: 11/875,433

(22) Filed: Oct. 19, 2007

Related U.S. Application Data
(60) Provisional application No. 60/862,144, filed on Oct. 19, 2006.

(51) Int. Cl. B41J 11/42

(52) U.S. Cl. 400/76

(57) ABSTRACT

This invention relates to methods and devices for applying a visual characteristic (e.g., a solid color) to a surface of a substrate (e.g., an immobile substrate such as a wall or ceiling) including methods and devices for scanning a surface of a substrate to detect a visual characteristic; comparing the scanned visual characteristic to a reference visual characteristic to determine a difference between the scanned visual characteristic and the reference visual characteristic; and applying pigment to the surface of the substrate with a printing head based at least in part on the determined difference.

### CROSS REFERENCE TO RELATED APPLICATIONS

Pursuant to 35 USC § 119(e), this application claims the benefit of prior U.S. Provisional Application 60/862,144, filed Oct. 19, 2006. The application is incorporated by reference in its entirety.

### TECHNICAL FIELD

This disclosure relates to the application of pigment to surfaces, and more particularly to controlled deposition of pigment to walls and/or ceiling to hide and/or cover scuffs or marks on these surfaces.

### BACKGROUND

Substrate surfaces, such as walls and ceilings, commonly receive accidental discolorations and marks that cannot be washed off. “Touching up” these spots with localized repair, e.g., repainting, may not solve the problem since pigment colors may differ with the surrounding surface regions due to aging. Hence, retouching is often as unsightly as the spot itself, so the damage usually remains until such time as the entire surface is repainted. This task becomes even more difficult when the surface carries imagery such as repeating patterns and text.

Devices have been developed for applying paint to surfaces, such as walls, with the aid of automation; however, these device can include cumbersome support structures and are often employed for covering an entire surface of a wall or like structure.

Still other devices, such as desktop and/or handheld printers and scanners, have been developed for both recording (i.e., scanning) visual characteristics from substrate surfaces (e.g., for subsequent reproduction) and for printing or depositing visual characteristics in select regions of substrate surfaces. However, even where both of these functions are provided in a single device, the printing and scanning functions are generally performed independently of each other.

### SUMMARY

The present invention features devices and methods for applying color to a surface region of a substrate, e.g., a wall, a ceiling and/or other large immobile surfaces, by matching an existing color of a surrounding surface region.

According to one aspect of the invention a method of applying a visual characteristic to a surface of a substrate includes scanning a first region of a surface of a substrate to detect a visual characteristic and comparing the scanned visual characteristic to a reference visual characteristic (e.g., a solid color, text, a pattern, or a picture) to determine a difference between the scanned visual characteristic and the reference visual characteristic. The method also includes applying pigment to the surface of the substrate with a printing head based at least in part on the determined difference.

In some cases, the first region is a blemish to the surface of the substrate. In these cases, for example, the reference visual characteristic can be a color of an unblemished region of the surface. In some examples, applying pigment to the surface of the substrate can include depositing a pigment on the blemished region to substantially match the color of the unblemished region.

The printing head can be configured to deliver an ink, a paint, and/or a dye.

In some examples, the method also includes recording a set of reference visual characteristic data corresponding to the reference visual characteristic, and reducing the detected visual characteristic to a set of scanned visual characteristic data. In some cases, the method includes scanning a second region on the surface of the substrate to detect the reference visual characteristic, and reducing the detected reference visual characteristic to the set of reference visual characteristic data. Recording the set of reference visual characteristic data can include storing the reference visual characteristic data on a computer readable memory module. In some cases, comparing the scanned visual characteristic to the reference visual characteristic includes comparing the scanned visual characteristic data to the reference visual characteristic data.

The printing head can be configured to modify a gloss level of the visual characteristic.

In some instances, the scanning is performed with a scanning sensor carried by a handheld device. The printing head can also carried by the handheld device. In these cases, scanning the first region of the surface and applying pigment to the surface can include manually displacing the device along the surface of the substrate. The steps of scanning the first region of the surface and applying pigment to the surface can be performed substantially concurrently.

In some situations, applying pigment to the surface of the substrate with the printing head includes reducing the detected difference to a set of control data, delivering an output signal corresponding to the set of control data to the printing head, and controlling operation of the printing head based at least in part on the output signal.

In some implementations, applying pigment to the surface of the substrate includes printing a visual characteristic (e.g., a solid color) on the surface of the substrate. The method can include calibration of the printed visual characteristic. Calibration can include, for example, printing a range of test colors on the surface of the substrate, scanning each of the test colors, comparing each of the test colors to the reference visual characteristic to determine a corresponding difference between each test color and the reference visual characteristic, and determining which of the test colors most closely matches the reference visual characteristic based on the determined corresponding differences. In some cases, a fixative or sealer is applied to the printed visual characteristic.

Printing the visual characteristic on the surface of the substrate can include manually displacing the printing head and/or the scanning sensor along the surface of the substrate. Manually displacing the printing head can include, for example, moving the printing head along the surface of the substrate in a back-and-forth motion. In some cases, displacing the printing head includes moving the printing head from a first location on the surface to a second location on the surface, and then removing the printing head from the surface at the second location and replacing the printing head on the surface at a third location, and then moving the printing head from the third location to a fourth location. In some cases, the third location is substantially the same as the first location, and the fourth location is substantially the same as the second location.

In some embodiments, the method includes repeating, in a series of iterations, the steps of moving the printing head from a first location on the surface to a second location on the surface, removing the printing head from the surface at the second location, replacing the printing head on the surface at a third location, and moving the printing head from the third location to a fourth location. In these embodiments, each iteration can include depositing a layer of pigment on the first region of the substrate. In some cases, each succeeding layer of pigment at least partially overlies the preceding one.

In some implementations, the method can include repeating, in a series of iterations as the printing head is displaced along the surface of the substrate, the steps of scanning a first region of a surface of a substrate to detect a visual characteristic, comparing the scanned visual characteristic to the reference visual characteristic to determine a difference between the scanned visual characteristic and the reference visual characteristic, and applying pigment to the surface of the substrate with the printing head based at least in part on the determined difference.

In some instances, the reference visual characteristic corresponds to one or more of tonality, reflectivity, and color.

In some situations, applying pigment to the surface of the substrate comprises depositing one or more of an ink, a dye, or paint carrying the pigment.

In some cases, the substrate is substantially immobile. The substrate can be disposed in a vertical position. For example, the substrate can be a wall or a ceiling.

In another inventive aspect, a method of applying a visual characteristic to a surface of a substrate includes depositing a grid of metallic material (e.g., metallic paint) on a surface of a substrate and utilizing one or more capacitive sensors to detect a position and/or orientation of a printing head relative to the grid. The method also includes manually displacing the printing head along the surface of the substrate and applying pigment to the surface of the substrate with the printing head based at least in part on the detected position and/or orientation of the printing head.

The method can also include scanning a reference visual characteristic and storing reference visual characteristic data corresponding to the reference visual characteristic to a computer readable memory module. In this case, applying pigment to the surface of the substrate with the printing head can include substantially reproducing the reference visual characteristic utilizing the reference visual characteristic data. Applying pigment to the surface of the substrate with the printing head can also include delivering an output signal corresponding to the reference visual characteristic to the printing head. The method can also include adjusting the output signal based on a detected change in position or orientation of the printing head relative to the grid.

In some embodiments, the method also includes monitoring the printed visual characteristic as the printing head is displaced along the surface of the substrate, and adjusting the output signal based on a detected difference between the reference visual characteristic and the printed visual characteristic. Monitoring can include scanning the printed visual characteristic, sending scanned visual characteristic data corresponding to the printed visual characteristic to a control processor, and comparing the scanned visual characteristic data to the stored reference visual characteristic data with the control processor to determine the detected difference.

The method can also include repeating the steps of scanning the printed visual characteristic, sending the scanned visual characteristic data to the control processor, and comparing the scanned visual characteristic data with the stored reference data, in a series of iterations as the printing head is displaced along the surface of the substrate until the detected difference is below a predetermined threshold value, as determined by the control processor, thereby signaling substantial reproduction of the reference visual characteristic.

In some implementations, depositing the grid of metallic material includes placing a stencil in a position adjacent the surface of the substrate, and exposing the stencil to a spray or mist comprising particles of the metallic material.

According to another aspect, a handheld printing and scanning device includes a housing and control electronics carried by the housing. The control electronics include a control processor and a computer readable memory module configured to communicate with the processor and operable to store a set of reference visual characteristic data corresponding to a reference visual characteristic. The device also includes one or more scanning sensors and a printing head. The scanning sensors are mounted to the housing and configured to communicate with the control electronics and operable to transmit visual characteristic signals representing scanned visual characteristics to the control electronics. The printing head is mounted to the housing and configured to communicate with the control electronics and arranged to receive an output signal from the control electronics, thereby to control operation of the printing head. The control electronics are configured to convert the visual characteristic signals to a corresponding sets of scanned visual characteristic data and control operation of the printing head based at least in part on a detected difference between the scanned visual characteristic data and the reference visual characteristic data.

In some embodiments, the device also includes a position sensor (e.g., a capacitive sensor, an optical sensor, or an encoder) in communication with the control electronics and configured to monitor a position and/or orientation of the device relative to a print surface. In some cases, the control electronics are configured to control operation of the printing head based at least in part upon a detected position and/or orientation of the device. In some implementations, the position sensor includes one or more wheels mounted to the housing and configured for frictional engagement with the print surface, and an encoder drivably connected to the one or more wheels.

In some embodiments, the device also includes a substrate sensor (e.g., a pressure sensor or a proximity sensor). The substrate sensor can be configured to communicate with the control electronics and operable to initiate activation of the scanning sensors and/or to initiate activation of the printing head.

In some implementations, the device also includes an accelerometer mounted to the housing and configured to communicate with the control electronics. In these cases, the control electronics are configured to receive an input signal corresponding to a movement of the device from the accelerometer, and control operation of the printing head based at least in part on the input signal.

In some cases, the one or more scanning sensors include a first scanning sensor and a second scanning sensor disposed on opposing sides of the printing head along an axis of motion of the device.

According to yet another aspect, a method of covering a blemish on an immobile surface includes providing a handheld printing and scanning device including a printing head and a scanning sensor. The device is placed on an immobile surface such that the scanning sensor is disposed proximate an unblemished region on the surface. A control processor is initiated to read a reference input signal corresponding to a color of the unblemished region from the scanning sensor. The input signal is reduced to a set of reference visual characteristic data corresponding to a mixture of color pigments that, when combined, substantially replicate the color of the unblemished region. The set of reference visual characteristic data is stored on a computer readable memory module. The device is manually displaced in a first direction over a blemished region on the immobile surface, and a mixture of color pigments substantially corresponding to the set of reference visual characteristic data is deposited on the blemished region of the immobile surface.

In some embodiments, the immobile surface is vertically oriented. The immobile surface can be a surface on a wall or ceiling.

In some implementations, the method includes iteratively comparing the color of the unblemished region with the deposited mixture of pigments.

In some cases, the method includes detecting a first local boundary of the blemished region with the scanning sensor as the device is displaced over the immobile surface, and, in response to detecting the first local boundary, activating the printing head. The method can also include detecting a second local boundary of the blemished region of the immobile surface with the scanning sensor as the device is displaced over the blemished region, and, in response to detecting the second local boundary, ceasing the operation of the printing head.

In some embodiments, the method can also feature lifting the device away from the surface and repeating the steps of placing the device on the immobile surface such that the scanning sensor is disposed proximate the unblemished region on the surface, manually displacing the device in a first direction over the blemished region, detecting a first local boundary of the blemished region, and, in response, activating the printing head, and detecting a second local boundary of the blemished region, and, in response to detecting the second local boundary, ceasing the operation of the printing head.

In other embodiments, the method includes displacing the device in a second direction, substantially opposite the first direction, over the blemished region, and detecting a second local boundary of the blemished region with the scanning sensor as the device is displaced over the immobile surface in the second direction. And, in response to detecting the second local boundary, causing the control processor to read a secondary input signal corresponding to a resultant color comprised of the color of the unblemished region, as modified by the mixture of color pigments deposited thereon. In these embodiments, the scanning sensor can include primary and secondary sensors disposed on opposing sides of the printing head and arranged such that at least one of the primary and secondary sensors precedes the printing head as the device is displaced over the blemished region in both of the first and second directions.

In some embodiments, the method includes comparing the resultant color with the color of the unblemished region. For example, comparing the resultant color with the color of the unblemished region can include reducing the secondary input signal to a set of scanned visual characteristic data, and comparing the set of scanned visual characteristic data to the set of reference visual characteristic data to detect a difference between the scanned visual characteristic data and the reference visual characteristic data.

Activating the printing head can include sending an output signal corresponding to control data from the control processor to the printing head to control the operation of the printing head. The method can also include adjusting the output signal based on the detected difference between the scanned visual characteristic data and the reference data.

In some cases, initiating the control processor to read the reference input signal comprises actuating a substrate sensor (e.g., a pressure sensor or a proximity sensor).

In some situations, depositing the mixture of color pigments includes initiating the control processor to deliver an output signal to the printing head, and controlling operation of the printing head based at least in part on the output signal. Initiating the control processor to deliver the output signal can include actuating a substrate sensor.

In some implementations, the method can also include calibrating the device. Calibrating the device can include printing a range of test colors bracketing the color of the unblemished region with the printing head, then scanning each of the test colors with the scanning sensor. Visual characteristic signals corresponding to the scanned test colors are then reduced to corresponding sets of visual characteristic data. Each set of visual characteristic data is compared to the reference visual characteristic data with the control processor to determine a difference between the set of visual characteristic data and the reference visual characteristic data for each of the test colors. Calibration also includes determining, with the control processor, which of the test colors most closely matches the color of the unblemished region based on the determined differences.

In some cases, scanning each of the test colors comprises manually moving the scanning sensors over the range of test colors.

Calibration can also include waiting for the printed test colors to stabilize (e.g., dry or cure) prior to scanning each of the test colors.

Printing the range of test colors can include printing a plurality of indicia (e.g., a bar code, or computer readable alphanumeric character or symbol) each corresponding to an associated one of the test colors. In some examples, the indicia correspond to a specific color of the associated test color. In some cases, the indicia correspond to parameters utilized by the control processor to produce the associated test color. In some embodiments, the indicia are printed adjacent the associated test color to form a plurality of indicia-test color pairs. In these embodiments, calibration can also include printing a separator feature adjacent each indicia-test color pair to indicate a boundary between adjacent ones of the indicia-test color pairs.

In some situations, the method also includes printing a range of secondary test colors bracketing the test color previously determined to most closely match the unblemished region; scanning each of the secondary test colors with the scanning sensor; reducing visual characteristic signals corresponding to the secondary test colors to corresponding sets of visual characteristic data; comparing each set of visual characteristic data to the reference visual characteristic data with the control processor to determine a difference between the set of visual characteristic data and the reference visual characteristic data for each of the secondary test colors; and determining, with the control processor, which of the secondary test colors most closely matches the color of the unblemished region based on the determined differences.

The method can also include repeating the steps of printing a range of secondary test colors bracketing the test color previously determined to most closely match the unblemished region; scanning each of the secondary test colors with the scanning sensor; reducing visual characteristic signals corresponding to the secondary test colors to corresponding sets of visual characteristic data; comparing each set of visual characteristic data to the reference visual characteristic data with the control processor to determine a difference between the set of visual characteristic data and the reference visual characteristic data for each of the secondary test colors; and determining, with the control processor, which of the secondary test colors most closely matches the color of the unblemished region based on the determined differences, until a determined difference between the color of the unblemished region and the test color that most closely matches the color of the unblemished region is below a predetermined threshold as determined by the control processor.

According to another aspect, a method of covering blemishes on a surface of an immobile substrate includes scanning a surface of an immobile substrate with the scanning sensor to detect a reference color; manually displacing a device having both a scanning sensor and a printing head over the surface of the substrate; and applying pigment to the surface with the printing head based at least in part on the detected reference color as the device is displaced over the surface of the substrate.

The method can also include detecting one or more blemishes on the surface of the substrate. In these cases, applying pigment to the surface can include printing over the detected blemishes.

In some instances, detecting the one or more blemishes includes scanning the surface with the scanning sensor as the device is displaced over the surface.

The method can also include scanning for blemishes while printing over detected blemishes as the device is displaced in a first direction over the surface of the substrate. For example, scanning for blemishes and printing over detected blemishes can be performed substantially simultaneously.

In some implementations, the device can also include a position sensor configured to detect a position of the device relative to the surface. In these implementations, printing over detected blemishes can include controlling actuation of the printing head based at least in part on a detected position.

In some cases, detecting one or more blemishes on the surface of the substrate includes comparing the reference color to a subsequently scanned visual characteristic. In these cases, the subsequently scanned visual characteristic can correspond to a color of a detected blemish.

In yet another aspect, a method of calibrating a color to be printed on a surface of an immobile substrate to match a reference color includes printing a range of test colors bracketing a reference color on a surface of an immobile substrate; scanning each of the test colors with a scanning sensor; reducing a plurality of visual characteristic signals, each corresponding to an associated one of the scanned test colors, to corresponding sets of test visual characteristic data with a control processor; comparing each set of test visual characteristic data with a set of reference visual characteristic data corresponding to the reference color with the control processor to determine a difference between the test visual characteristic data and the reference visual characteristic data for each test color; and determining which of the test colors most closely matches the reference color based on the determined differences.

In some examples, each of the scanning sensor, the printing head, and the control processor are carried by a handheld device. In these examples, printing the range of test colors and scanning each of the test colors can include manually displacing the device over the surface of the substrate in consecutive passes. For example, in some cases, the steps of printing and scanning are each performed in a corresponding pass over the surface of the substrate as the device is displaced in a back-and-forth motion across the surface.

In some embodiments, the device also includes one or more position sensors configured to detect a position of the device relative to the surface of the substrate. The test color determined to most closely match the color of the unblemished region can be correlated with parameters utilized by the control processor to produce the associated test color based at least in part on a detected position of the device.

In some cases, printing the range of test colors includes printing a plurality of indicia (e.g., OCR readable characters or symbols, and/or bar codes) each corresponding to an associated one of the test colors. The indicia can be disposed between adjacent ones of the test colors. The indicia can correspond to parameters utilized by the control processor to produce the associated test color. The indicia can also correspond to a specific color on an absolute scale.

In some instances, the reference color corresponds to a color of an unblemished region on the surface of the substrate. In these instances, printing the range of test colors can include printing the range of test colors on a blemished region on the surface of the substrate. The method can also include substantially covering the blemished region with the test color determined to most closely match the reference color. Substantially covering the blemished region can include, for example, depositing a mixture of color pigments that, when combined, substantially replicate the test color determined to most closely match the reference color.

In some embodiments, printing comprises depositing paint on the surface of the substrate.

In some cases, the substrate is disposed in a vertical position. The substrate can be a wall or a ceiling.

According to another embodiment, a handheld printing and scanning device includes a housing, a control processor, and one or more scanning sensors mounted to the housing and configured to communicate with the control processor. The scanning sensors are operable to transmit visual characteristic signals representing scanned visual characteristics to the control processor. The device also includes a position sensor and a printing head. The position sensor is carried by the housing and configured to communicate with the control processor to monitor a position and/or orientation of the device relative to a print surface. The printing head is mounted to the housing and configured to communicate with the control processor and arranged to receive an output signal from the control processor, thereby to control operation of the printing head. The control electronics are configured to convert the visual characteristic signals to corresponding sets of scanned visual characteristic data and control operation of the printing head based at least in part on the scanned visual characteristic data and a detected position and/or orientation of the device.

In some embodiments, the position sensor includes one or more wheels mounted to the housing and configured for frictional engagement with the print surface, and an encoder drivably connected to the one or more one or more wheels and configured to transmit the position signals to the control processor.

In some implementations, the device is configured to scan for blemishes on the print surface while printing over detected blemished.

In some constructions, the device can include a substrate sensor (e.g., a pressure sensor or a proximity sensor) configured to communicate with the control processor and operable to initiate activation of the scanning sensors and/or the printing head.

In some examples, the device also includes an accelerometer mounted to the housing and operable to transmit an input signal corresponding to a movement of the device to the control processor. In these examples, the control processor can be configured to control operation of the printing head based at least in part on the input signal.

In some instances, the one or more scanning sensors include a first scanning sensor and a second scanning sensor disposed on opposing sides of the printing head along an axis of motion of the device.

In another inventive aspect, a method of altering a visual appearance of a surface includes moving a device over a reference region of the surface while scanning the reference region with the device; storing reference data corresponding to a visual characteristic of the reference region; and moving the device over a target region of the surface while applying pigment to the target region of the surface with the device, thereby altering a visual characteristic of the target region to correspond with the visual characteristic of the reference region.

Some implementations of this aspect also include scanning the target region with the device to generate target data corresponding to an unaltered visual characteristic of the target region; and comparing the target data to the reference data to determine a visual difference between the target and reference regions.

The new devices and methods provide for the repair of discolorations and spots on walls, ceilings and/or other surfaces without repainting or re-covering the entire surface. The new devices and methods allow for manually controlled printing and scanning with electronically controlled error adjustment. Manual control (i.e., corresponding to physiological motion of an operator) provides for unconstrained control relative to the print surface in all three axes. Furthermore, manual (e.g., hand-held) control offers reduced setup time such that the new devices can be used for frequent (e.g., daily) touch up of high-use and/or high-value locations; easy to transport; and can work on ceilings and sloped walls. The new devices can be used to repair small walls, curved walls, and walls that are broken up by beams or other such architectural features. The new device and methods provide for the application of imagery such as patterns and text and to walls, ceilings and other large immobile surfaces with built-in alignment and error adjustment control. The devices and methods can provide for reduced material cost, both in financial and environmental terms, as repainting entire surfaces may require the utilization of large amounts of petroleum-based materials. Labor requirements may also be reduced, since only discrete areas (e.g., blemished areas) need to be attended to, rather than entire surfaces. In addition, surfaces may be maintained constantly, always appearing new, rather than going through cycles of new and old.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a plan view of a handheld printing and scanning device.

FIG. 2 is a flow chart of a method for repairing a blemished region on a surface of a substrate.

FIG. 3A is a plan view of a wall having a localized region of discoloration (a spot).

FIG. 3B is a plan view of the wall of FIG. 3A in a first stage of repair.

FIG. 4 is a handheld printing and scanning device including position and/or location detection features.

FIG. 5 is a grid for use in conjunction with certain implementations of the printing and scanning device of FIG. 5.

FIG. 6 is a plan view of a printed range of test colors for calibrating the device of FIG. 1.

Like reference symbols in the various drawings indicate like elements.

### DETAILED DESCRIPTION

The new devices and methods can be used to deposit pigments on a surface of a substrate, e.g., the surface of a wall, to form a visual characteristic. For example, the new devices and methods can be employed to remove, hide and/or cover scuffs or marks on a blemished region of a wall, ceiling or other surface by depositing pigments to match a color of an unblemished, surrounding surface region.

### A Handheld Printing and Scanning Device

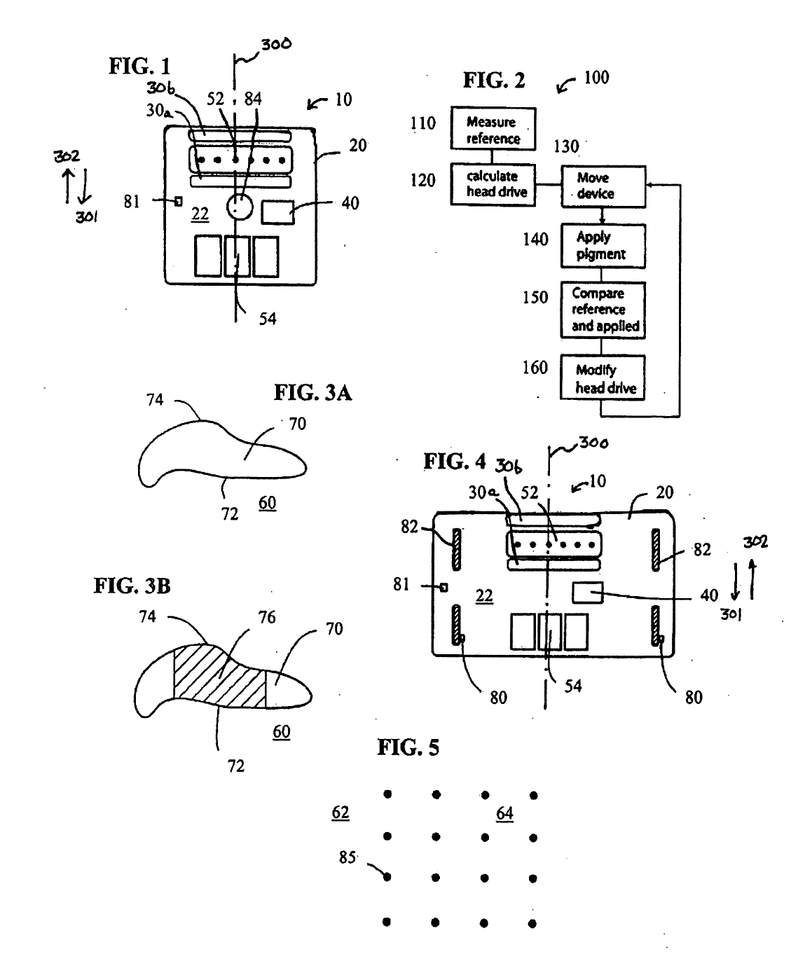

In certain embodiments the invention includes new devices 10 for printing a visual characteristic, e.g., depositing a pigment or pigments, e.g., liquefied pigmented material, e.g., ink, paint, or dye, on a surface of a substrate while dynamically scanning the surface of the substrate to monitor the printed visual characteristic. As shown, for example, in FIG. 1, the new devices generally include at least four main components including (i) a housing 20; (ii) one or more scanning sensors 30a, 30b; (iii) control electronics 40; and (iv) one or more printing heads 52.

The housing 20 accommodates the scanning sensors 30a, 30b, control electronics 40 and the printing heads 52. Preferably, the housing 20 is sized for handheld (i.e., manual) operation of the device 10. The housing 20 defines a working surface 22 of the device 10. As illustrated in FIG. 1, the printing heads 52 are mounted in the housing 20 such that the printing heads 52 are exposed at the working surface 22. The scanning sensors 30 (i.e., color scanning sensors) as mounted in the housing 20 such that the scanning sensors 30 are exposed at the working surface 22.

The scanning sensors 30a, 30b are generally used for measuring color, reflectivity (gloss) and/or tonality of an opposing surface. Scanning sensors of this kind are well known and can be selected, for example, from those found in commercially available desktop scanners. However, unlike commercial scanning applications, the scanning sensors 30a, 30b of device 10 are used on both absolute and relative scales. For example, as described in greater detail in the paragraphs that follow, the scanning sensors 30 of the disclosed device 10 are used not only for detecting a visual characteristic (including one or more of color, reflectivity and/or tonality) for the purpose of recording the visual characteristic, but also for detecting a visual characteristic for comparison with known (e.g., previously recorded) visual characteristic data. The scanning sensors 30 are arranged in communication with the control electronics 40. In operation, the scanning sensors 30a, 30b generate visual characteristic signals (e.g., electrical signals) corresponding to a scanned visual characteristic and transmit the signals to the control electronics 40 for downstream data manipulation and storage.

The control electronics 40 generally include a control processor 42 and a computer readable memory module 44 arranged in communication with the control processor. In some cases, for example, the control processor 42 and the memory module 44 are embodied in single computing device such as a microprocessor. The control processor 42 is in communication with the scanning sensors 30a, 30b and is configured to read/receive the visual characteristic signals from the sensors 30a, 30b and to reduce the visual characteristic signals to a manipulable set of visual characteristic data. In some cases, the set of visual characteristic data is delivered to the computer readable memory 44 for storage. In other cases, the control processor 42 compares the set of visual characteristic data to a set reference visual characteristic data (e.g., previously recorded/stored visual characteristic data). The control processor 42 is also in communication with the printing heads 52. In operation, the control processor 42 translates control data, corresponding, at least in part, to the visual characteristic data obtained from the scanning sensors 30, 30b, to an output signal and transmits the output signal to the printing heads 52, thereby controlling operation of the printing heads 52. In this sense, the control electronics 40 serve as a conduit for conveying information from the scanning sensors 30a, 30b to the printing heads 52.

The printing heads 52 can be selected from a variety of known printing devices and technologies such as those incorporated in dot matrix and inkjet printing devices. In general, with inkjet devices, pigment, (e.g., ink, paint, or dye) ejection is controlled by pressurizing the medium with an actuator, which may be, for example, a piezoelectric actuator, a thermal bubble jet generator, or an electrostatically deflected element. Inkjet printing heads typically include an array of ink pathways with corresponding nozzle openings and associated actuators, such that drop ejection from each nozzle opening can be independently controlled. Dot matrix printers generally include a printing head that runs back and forth across a receiving surface of a substrate (e.g., paper) and prints by impact, e.g., striking an ink-soaked cloth ribbon against the substrate. Another suitable printing device is described in U.S. Pat. No. 6,090,445 to Anderson, the entire disclosure of which is incorporated herein by reference. Anderson describes a paint injector that advances a strand (e.g., a wire hoop, a band or a ribbon) coated with ink or paint through the path of a fluid (air) stream. The air stream removes the ink/paint from the exterior of the strand and deposits it onto the surface of an adjacent print medium (i.e., substrate). A microprocessor or other controlling device controls the strand so that the speed of the strand's advance through the air stream meters the quantity of paint injected into the air stream.

Regardless of the particular printing technology employed in device 10, in each case the printing heads 52 are controlled by electrical signals transmitted from the control processor 42. The pigment(s) are provided to the printing heads 52 from pigment reservoirs 54, which are in fluid communication with the printing heads 52. Typically, each reservoir 54 contains a different color pigment. The pigment can be black, cyan, magenta, yellow, red, blue, green, or a mixture these colors. In some embodiments, the pigments can also include a fixative, sealer, or an additive to increase reflectivity of the printed visual characteristic. The pigments can be disposed and/or carried in or by an ink, paint, or dye. In operation, the control processor 42 identifies an appropriate mixture of pigments (i.e., for achieving a desired output, e.g., a printed visual characteristic) according to a predetermined algorithm, this information is transmitted to the printing heads 52 in the output signal. The mixture may need to take into account color variations due to drying or curing of the pigments and/or drying or curing of a medium carrying the pigments. In summary, the control processor 42 receives input data from the scanning sensors 30a, 30b and controls the printing heads 52 to produce a desired pigment output.

A variety of known color blending techniques and technologies can be employed for achieving the desired output. Generally, one known method for creating color includes closely positioning different amounts of key primary colors, e.g., cyan, yellow, magenta and black, on a surface of a substrate, which, from extended distances, merge to form any color under a process known as dithering. The primary colors can be dithered to form the entire color spectrum. Dithering breaks a color pixel into an array of dots so that each dot is made up of one of the basic colors (or otherwise left blank).

### Methods of Operation

Generally, the device 10 can detect a reference color of the wall, e.g., by placing the scanning sensors 30a, 30b in close proximity to an un-marked (i.e., clean) region of the wall. With a reference color detected, a user can move the device 10 back and forth over a discoloration or mark (i.e., blemish) on the surface of a wall. With each pass, the scanning sensors 30a, 30b will scan the surface to detect any mismatch or discoloration between the scanned surface and the reference color. Arranging each of the respective scanning sensors 30a, 30b on opposing sides of the printing heads 52 (as shown in FIG. 4), along a motion axis 300 of the device 10, can aid in assuring that one of the sensors 30a, 30b precedes the printing heads 52 in each pass over the blemish in both of two opposing directions 301, 302. Or, alternatively, the user can repeatedly slide the device 10, e.g., in one direction (e.g., 301), over the blemish, each time sliding across the blemish then lifting, returning approximately to the start position and again sliding across the blemish. If a mismatch is detected the printer will deposit a print medium (e.g., paint, ink, or dye) in the region of the mismatch to better match that region to the reference color.

FIG. 2 illustrates one embodiment of a method 100 for removing spots from a surface of a substrate using the device 10. In step 110, a reference color is measured by the scanning sensors 30. In step 120, the control processor 42 calculates the level at which each of the printing heads 52 will be driven to attempt to reproduce the measured reference color. In step 130, the user moves the device over a spot (e.g., a scuff, mark, or discoloration) on the surface of the substrate. In step 140, a pigment or pigments are applied to the spot. In step 150, the scanning sensors 30a, 30b take a new measurement in the region of the spot where the pigment has been applied and the control processor 42 compares this new measurement to that of the reference color. In step 160, control of the printing heads 52 is modified to reduce variation between the applied and the reference color. As indicated by arrow 170, steps 130-160 are then repeated in a series of iterations until the applied pigments substantially reproduce the reference color. In some embodiments, each subsequent motion is in an opposite direction to the one preceding it.

Referring to FIGS. 1 and 3A, a user begins by placing the device 10 on an unblemished region on a surface of a substrate (e.g., wall 60) and initiating the control processor 42 to read a visual characteristic signal corresponding to the unblemished region from the scanning sensors 30a, 30b. The control processor 42 reduces the visual characteristic signal to a corresponding set of reference visual characteristic data, stores this data to the computer readable memory 44, and begins the process of identifying an appropriate mixture of pigments that correspond to the reference visual characteristic data.

The user then slides the device 10 over a marred or discolored region (i.e., spot 70) of the wall 60. As the scanning sensors 30 pass over a first edge 72 the control processor 42 identifies this as a first local boundary of the spot 70. This process of identification includes reading signals corresponding to the scanned visual characteristic (i.e., the spot 70) and reducing the signals to scanned visual characteristic data for comparison with the stored reference visual characteristic data. The control processor 42, upon detecting a difference (e.g., a difference in color), based on a comparison between the reference visual characteristic data and the scanned visual characteristic data, transmits an output signal to the printing heads 52, which, in turn, begins to apply pigments to the surface of the spot 70.

As the scanning sensors 30a, 30b pass a second edge 74 of the spot 70, the processor 42 identifies this as a second local boundary and ceases the activity of the printing heads 52 (i.e., stops applying pigments). This operation need not be precise. FIG. 3B illustrates the discolored region of the wall 60 after the first traverse of the spot 70, in which a swath of a transition area 76 has been coated with one or more pigments. However, as indicated by hatched lines of FIG. 3B, the color match (i.e., between the deposited pigment(s) and the unblemished region (reference visual characteristic)) may not be exact. In this case, the user will then move the device 10 backwards over the spot 70. As the scanning sensors 30a. 30b pass the second edge 74 the control processor 42 takes new color measurements which are then used relative to the stored reference visual characteristic data. The output signal of the control processor 42 is adjusted accordingly, such that the pigments are deposited in a series of iterations as the device 10 is traversed along the surface of the wall 60. In this manner, the reference visual characteristic obtained from the unblemished region is gradually reproduced in the discolored region. The objective is not necessarily to reproduce the reference visual characteristic (e.g., reference color, e.g., a solid color) on an absolute scale, but to measure differences between the reference visual characteristic and the spot 70 in each iteration and to gradually reduce variations, e.g., in color, saturation, and/or gloss, between the spot 70 and the reference color.

This can be beneficial due to inherent inaccuracies in each of the scanning sensors 30a, 30b, the pigments and the printing heads 52. By repeatedly traversing the region of iteratively applied pigment(s), the control processor 42 can match the reference color with increasing accuracy. Fuzzy logic, artificial intelligence or traditional comparison techniques may be used to control activation of the printing heads 52 to reduce detected variations.

The user can continue to move the device 10, e.g., in back-and-forth motions, across the spot 70, until a combination of printed pigments provide an accurate representation (i.e., substantial reproduction) of the reference visual characteristic (e.g., a solid color, a picture, text, or a pattern, e.g., a repeating pattern). This can be determined visibly by the user, or automatically with the aid of the control processor 42. For example, the control processor 42 can be configured to cease actuation of the printing heads 52 once the detected difference between the scanned visual characteristic data and the reference visual characteristic data falls below a predetermined threshold value. Some portions of the wall 60 may have different coloring due, for example, to greater exposure to light (e.g., sun light) or heat. Extra motions, e.g., back-and-forth, allows the device 10 to adjust the output (i.e., the printed pigments) to match a localized reference color.

### Other Embodiments

A number of embodiments of the invention have been described. Nevertheless, it will be understood that various modifications may be made without departing from the spirit and scope of the invention.

For example, in some embodiments the device 10 includes a substrate sensor 81, such as a pressure switch, mounted to the housing 20 along the working surface 22 of the device 10 so that forced contact with a substrate will can be used to indicate a user's intent to being operation. Some embodiments may also include an indicator light (not shown) for indicating a “ready” to the user once a reference color has been sensed.

Some embodiments can include an accelerometer, or other motion sensing device, for detecting movement of the device 10. The accelerometer can be used, for example, to better integrate a user's motion with device output, such as reducing the application of pigment(s) at a periphery of repair, thereby to provide a feathered edge.

In some embodiments, a peep hole 84 is provided, e.g., defined by and/or extending though the housing, to allow the user to view the printed visual characteristic as the working surface 22 of the device 10 is displaced along the surface of the substrate.

During use, knowledge of the location of the device 10 may be used to apply an increasingly light coat at the periphery of repair, thereby producing a feathered edge. Therefore, in some embodiments, the device 10 includes one or more location sensors 80 (FIG. 4). For example, FIG. 4 shows one embodiment of the device 10 that includes wheels 82 and location sensors 80. Location sensor 80 can be encoders, e.g., drivably connected to the wheels 82, for measuring displacement of the wheels 82. The location sensors 80 can also be other sensing technology (such as optical or capacitive) to measure displacement along a surface of a substrate directly.

In these cases, the control processor 42 can be configured to incorporate information provided by the location sensors 80 to more accurately start and stop the deposition of pigments as the printing heads 52 cross over edges of a marred or discolored region. Knowledge of these edge locations allows the control processor 42 to “feather” or blend the edges with increasingly light applications of the final color at a periphery of repair, thereby providing a subtle blend to further hide any color variation with the surrounding surface regions. Because the sensor(s) 30 may not be co-located exactly with the printing heads 52, an offset may be used to better coordinate the transients of starting and stopping material pigment application. The offset may be based on time, distance, velocity or acceleration, or a combination thereof Two scanning sensors, one on either side of the printing heads 52, may be used to provide processor 42 color information in advance of print heads 52, regardless of the motion of travel. As an alternative, or in addition to multiple scanning sensors, reflective surfaces may to used to direct sensory data from a plurality of locations.

In addition, by accurately detecting the location and orientation of the device 10 with respect to text or a visual characteristic on the surface of the substrate, the device may be used to refurbish damaged text and visual characteristics (e.g., faded regions on wall paper). In the same manner, the device may be used to create new visual characteristics.

In some embodiments, referring to FIG. 5, a grid 85 can be applied to a surface 64 of a substrate 62 to provide additional location reference for the device 10. In this embodiment, a non-extensible sheet (such as Mylar®) having a matrix of holes arranged in a pattern corresponding to grid 85 can be used as a template, temporarily affixed to the surface so that a metallic material (e.g., metallic paint) can be sprayed on the surface 64. The sheet is then removed leaving grid 85. Utilizing location sensors 80 that operate on a capacitive principle allows the device 10 to maintain accurate location information with respect to the surface 64, even after pigment has been disposed. As the user displaces the device 10 along the surface 64, the device 10 uses the location sensors 80 in combination with the grid to determine an absolute position of the device 10 with respect to the grid 85. Additional location sensors can be used to provide additional relative location information. Once deposition of a visual characteristic on the surface 64 has begun, the device 10 may use the visual characteristic itself (via grid 85) to re-establish orientation after the device has been disengaged from the surface. By using a plurality of printing heads, each supplying a different color of pigment, and by controlling and coordinating the metering of the spray from each according to this accurate location information, while accounting for error diffusion, stochastic screening or blue noise algorithms as known in the art, the device may be used to produce any visual characteristic on the surface.

In some cases, multiple blemished regions on a surface of the substrate can be treated. For example, in one embodiment the user slides device 10 over an area on the of a substrate having multiple blemished regions, all the while continuously scanning to detect the local boundaries of each blemished region, while at the same time controlling operation of the printing head to deposit pigment only on the blemished regions.

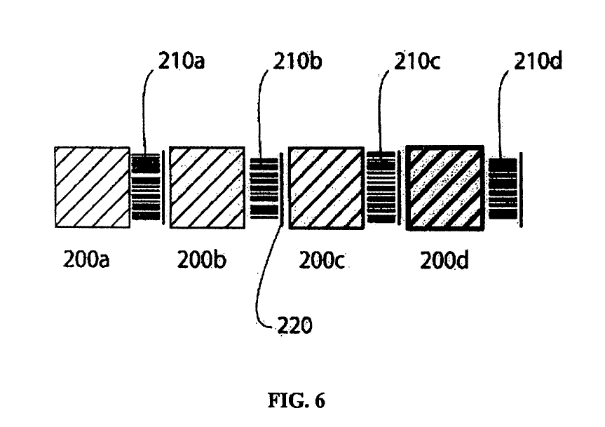

In some embodiments, the device is used with a calibration step, as illustrated in FIG. 6, in which the device 10 prints a range of test colors 200, calculated to “bracket” the reference color 110, such that an approximation of the reference color will be printed somewhere in the range 200a-200d. A second phase of the calibration step includes waiting until the pigment color has stabilized (such as drying in the case of a paint) and then manually moving the device 10 over the range of test colors 200a-200d to identify which of test colors most closely matches the reference color. Specific colors in the test range 200a-200d may be identified with indicia 210a-210d, respectively, printed by printing heads 52 as the test range 200 is printed, and readable by the scanning sensors 30 on a subsequent pass. Indicia 210 may identify a specific color on an absolute scale, but in the preferred embodiment, indicia 210 is used to associate each individual calibration test color with the parameters that control processor 42 used to produce it. Indicia may be a bar code or the like, or human-readable symbols rendered machine-readable by optical character recognition (OCR). Feature 220 serves to group indicia/sample pairs. In the embodiment depicted in FIG. 4, the test color most closely matching the reference color can be correlated with the control parameters used to produce that test color by measuring the distance (i.e., with location (position) sensors 80) from a start point and referencing the control parameters from the memory module 44. After the device 10 has identified the test color which best matches the reference color, the process may be repeated to increase the accuracy. In addition, a manual accuracy setting can be implemented to allow the user to perform the calibration over successively narrow ranges 200 until a very high accuracy color match is achieved. Once the device 10 is calibrated to match the reference color, it may be used to cover discolorations, including the marks made during the calibration process.

Accordingly, other embodiments are within the scope of the following claims.

1. A method of applying a visual characteristic to a surface of a substrate, the method comprising:
scanning a first region of a surface of a substrate to detect a visual characteristic;
comparing the scanned visual characteristic to a reference visual characteristic to determine a difference between the scanned visual characteristic and the reference visual characteristic; and
applying pigment to the surface of the substrate with a printing head based at least in part on the determined difference.

2. The method according to claim 1, wherein the first region includes a visual blemish on the surface.

3. The method according to claim 2, wherein the reference visual characteristic is a color of an unblemished region of the surface.

4. The method according to claim 3, wherein applying pigment to the surface of the substrate comprises depositing a pigment on the blemished region to substantially match the color of the unblemished region.

5. The method according to claim 1, wherein the reference visual characteristic is selected from the group consisting of: a solid color, text, a pattern, and a picture.

6-10. (canceled)

11. The method according to claim 1, wherein the printing head is configured to modify a gloss level of the visual characteristic.

12. The method according to claim 1, wherein the scanning is performed with a scanning sensor carried by a handheld device, and wherein the printing head is also carried by the handheld device.

13. The method according to claim 12, wherein scanning the first region of the surface and applying pigment to the surface comprises manually displacing the device along the surface of the substrate.

14-17. (canceled)

18. The method according to claim 16, further comprising calibrating the printed visual characteristic including:
printing a range of test colors on the surface of the substrate;
scanning each of the test colors;
comparing each of the test colors to the reference visual characteristic to determine a corresponding difference between each test color and the reference visual characteristic; and
determining which of the test colors most closely matches the reference visual characteristic based on the determined corresponding differences.

19. (canceled)

20. The method according to claim 1, wherein applying pigment to the surface of the substrate comprises manually displacing the printing head along the surface of the substrate.

21-27. (canceled)

28. The method according to claim 1, wherein the reference visual characteristic corresponds to one or more of tonality, reflectivity, and color.

29-30. (canceled)

31. The method according to claim 1, wherein the substrate is substantially vertical.

32. The method according to claim 1, wherein the substrate is a wall or a ceiling.

33. A method of applying a visual characteristic to a surface of a substrate, the method comprising:
depositing a grid of metallic material on a surface of a substrate;
utilizing one or more capacitive sensors to detect a position and/or orientation of a printing head relative to the grid;
manually displacing the printing head along the surface of the substrate; and
applying pigment to the surface of the substrate with the printing head based at least in part on the detected position and/or orientation of the printing head.

34-80. (canceled)

81. A method of covering blemishes on a surface of an immobile substrate, the method comprising:
scanning a surface of an immobile substrate with the scanning sensor to detect a reference color;
manually displacing a device having both a scanning sensor and a printing head over the surface of the substrate;
and
applying pigment to the surface with the printing head based at least in part on the detected reference color as the device is displaced over the surface of the substrate.

82. The method according to claim 81, further comprising detecting one or more blemishes on the surface of the substrate, wherein applying pigment to the surface comprises printing over the detected blemishes.

83. The method according to claim 82, wherein detecting the one or more blemishes comprises scanning the surface with the scanning sensor as the device is displaced over the surface.

84. The method according to claim 82, further comprising scanning for blemishes while printing over detected blemishes as the device is displaced in a first direction over the surface of the substrate.

85. The method according to claim 84, wherein scanning for blemishes and printing over detected blemishes are performed substantially simultaneously.

86. The method according to claim 82, wherein the device further comprises a position sensor configured to detect a position of the device relative to the surface, and wherein printing over detected blemishes comprises controlling actuation of the printing head based at least in part on a detected position.

87. The method according to claim 82, wherein detecting one or more blemishes on the surface of the substrate comprises comparing the reference color to a subsequently scanned visual characteristic.

88. The method according to claim 87, wherein the subsequently scanned visual characteristic corresponds to a color of a detected blemish.

89. A method of calibrating a color to be printed on a surface of an immobile substrate to match a reference color, the method comprising
printing a range of test colors bracketing a reference color on a surface of an immobile substrate;
scanning each of the test colors with a scanning sensor;
reducing a plurality of visual characteristic signals, each corresponding to an associated one of the scanned test colors, to corresponding sets of test visual characteristic data with a control processor;
comparing each set of test visual characteristic data with a set of reference visual characteristic data corresponding to the reference color with the control processor to determine a difference between the test visual characteristic data and the reference visual characteristic data for each test color; and
determining which of the test colors most closely matches the reference color based on the determined differences.

90-112. (canceled)

113. A method of altering a visual appearance of a surface, the method comprising:
moving a device over a reference region of the surface while scanning the reference region with the device;
storing reference data corresponding to a visual characteristic of the reference region; and
moving the device over a target region of the surface while applying pigment to the target region of the surface with the device, thereby altering a visual characteristic of the target region to correspond with the visual characteristic of the reference region.

114. The method according to claim 113, further comprising:
scanning the target region with the device to generate target data corresponding to an unaltered visual characteristic of the target region; and
comparing the target data to the reference data to determine a visual difference between the target and reference regions.
